(19) United States
(12) Patent Application Publication
(10) Pub. No.: US 2005/0200588 A1
(43) Pub. Date: Sep. 15, 2005

(54) Liquid crystal display device

(75) Inventor: Harutoshi Kaneda, Saitama-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/062,839

(22) Filed: Feb. 23, 2005

(30) Foreign Application Priority Data
Feb. 23, 2004 (JP) P2004-046899

(51) Int. Cl. G09G 3/36

(52) U.S. Cl. 345/98

(57) ABSTRACT

Liquid crystal display device 1 includes pixels PX, individual and common electrodes PE and CE provided for pixels PX and flicker compensation circuit 8. Flicker compensation circuit 8 changes a central level of common voltage Vcom for common electrode CE. Flicker compensation circuit 8 is provided with capacitor 31, variable resistor 32, switch 34, arithmetic operation circuit 33 and buffer amplifier 35. Capacitor 31 supplies common voltages Vcom from common voltage generation circuit 6. Variable resistor 32 changes common voltages Vcom while switch 34 selects one of two different voltages VCC1 and VCC2. Arithmetic operation circuit 33 combines an output of variable resistor 32 with that of switch 34 and buffer amplifier 35 supplies thus combined outputs V'com to common electrode CE as compensated common voltages.

### FIELD OF THE INVENTION

This invention generally relates to a liquid crystal display device and, more particularly, to a flicker compensation circuit provided for a liquid crystal display device which has display modes of erecting and reversed images, for example, and makes use of adjacent gate lines to define auxiliary capacitors to hold pixel voltages.

This application is based upon and claims the benefit of priority from the prior Japanese Patent Application No. 2004-46899, filed on Feb. 23, 2004, the entire contents of which are incorporated herein by reference.

### RELATED ART

Flat panel displays, such as liquid crystal displays, for representative example, are applied in personal computers, portable information terminals, television sets, car navigation systems or the like.

A liquid crystal display device is usually provided with a pixel-matrix-array display panel and driving circuit to drive the same. The display panel has typically pixel-array and counter substrates and a liquid crystal layer held between the pixel-array and counter substrates. The pixel array substrate includes pixel electrodes disposed in a matrix form, gate electrode lines provided along lines of the pixel electrodes, source electrode lines provided along rows of the pixel electrodes and switching elements arranged in the vicinity of crossing points of the gate and source electrode lines. Each switching element is composed of a thin film transistor which electrically connects the source electrode line to the pixel electrode when the thin film transistor is enabled in response to a control signal applied to its gate electrode line. A counter electrode provided on the counter substrate is disposed opposite to the pixel electrodes provided on the pixel array substrate.

The driving circuit converts digital display signals assigned to pixels along each gate line of the matrix into pixel voltages during every horizontal scanning period and supplies such pixel voltages in parallel to the source electrode lines. The pixel voltages are then provided to the pixel electrodes through the switching elements, the gate electrodes of which are driven by the control signals applied to the gate electrode lines. A common voltage is supplied to the common electrode. Each pixel is composed of a pair of the pixel and common electrodes and the liquid crystal layer so that a liquid crystal molecular disposition in every pixel region is controlled by an electric field applied between the pixel and common electrodes. Direction of the electric field is reversed at every horizontal scanning period by reversing levels of voltages applied between the pixel and common electrodes.

The pixel electrodes of the liquid crystal display device change to a floating state when the switching elements turn off after a lapse of every horizontal scanning period. At that time, an electric charge held by the pixel electrode moves, so that stray capacitors of the switching element are charged with the electric charge and electric potential at the pixel electrode decreases. Thus, the display panel usually includes auxiliary capacitors which are disposed in parallel with the gate electrode lines and are provided between auxiliary capacitor lines and the pixel electrodes while the auxiliary capacitors are set to a predetermined potential. The capacitance values of the auxiliary capacitors are set to be large enough to compensate for those electric charges with which the stray capacitors of the switching elements are charged and to effectively reduce the decrease of the electric potential at the pixel electrodes. Recently, a new technology has been proposed to use the gate electrode lines for such auxiliary capacitors as well, so that no auxiliary capacitor lines are needed (see Japanese Unexamined Patent Publication No. Tokkaihei 6-16090, for instance). The auxiliary capacitor for each pixel is defined by capacitive coupling of the pixel electrode and the gate electrode line to control the switching elements of its adjacent pixels in the row.

Meanwhile, it is necessary to install a liquid crystal display device used for a car navigation system in a space available around the driver's seat. As a result, such a space is located at a place where a driver looks up or down at the display panel. A pre-tilted angle of liquid crystal molecules, however, is set up for the liquid crystal display device to have sufficient right and left viewing angles at the cost of either the upper or lower viewing angle. In other words, gray-scale images displayed on the display panel are reversed in either the upper or lower direction. Thus, it is desired that the vertical scanning direction can be reversed to prevent reversed images when the images are viewed from a non-reversed gray-scale side on such a condition that the display panel is turned upside down.

In the case that the vertical scanning direction on the display panel is reversed, it is quite difficult to properly decrease flicker noises. Since the auxiliary capacitors are defined by the gate electrode lines of neighboring pixels, flicker noises during the going-down scanning are different from those during the coming-up scanning. To suppress this phenomenon, two-component variable resistors may be provided to adjust the common voltages independently for the going-down and coming-up scanning. Resistors have, however, temperature characteristics to change their resistance values in accordance with ambient temperatures. In addition, it takes time to properly adjust both two-component variable resistors, so that high productivity of the display device cannot be expected.

### SUMMARY OF THE INVENTION

Accordingly, the present invention provides a liquid crystal display device with a flicker compensation circuit which exhibits less temperature dependency and improves productivity of the display device.

One aspect of the present invention is directed to a liquid crystal display device provided with pixels, individual and common electrodes provided for the pixels, and a flicker compensation circuit. A flicker compensation circuit includes a capacitor through which common voltages are supplied to the flicker compensation circuit, a variable resistor which changes the common voltages supplied through the capacitor, a switch which selects one of two different voltages, and an output circuit which combines an output of the variable resistor with that of the switch and supplies thus combined outputs to the common electrode as compensated common voltages.

A second aspect of the present invention is directed to a liquid crystal display with the flicker compensation circuit which further includes a controller to selectively control a first display mode with a first vertical scanning direction and a second display mode with a second vertical scanning direction reverse to the first vertical scanning direction.

A third aspect of the present invention is directed to a liquid crystal display device with the flicker compensation circuit set forth above in which the switch selects a first voltage at the first display mode and a second voltage at the second display mode.

A fourth aspect of the present invention is directed to a liquid crystal display device which can be used for a car.

A fifth aspect of the present invention is directed to a flicker compensation circuit which includes a capacitor through which a common voltage is supplied, a variable resistor which changes the common voltage supplied through the capacitor, a switch which selects one of two different voltages, and an output circuit which combines an output of the variable resistor with that of the switch.

In the flicker compensation circuit, the variable resistor is used to adjust a central level of the common voltages while the output circuit adds such an adjusted result to one of the two different voltages selected by the switch. Further, a single component of the variable resistor may be sufficiently adjustable for the output circuit to set the compensated common voltage for the suppression of two kinds of flicker noises. Thus, the compensation circuit with the single component variable resistor is less influenced by ambient temperature than the conventional compensation circuit with two-component variable resistors. Further, the former takes shorter adjustment time than the latter, so that the productivity of the display is significantly improved.

### BRIEF DESCRIPTION OF THE DRAWINGS

A more complete appreciation of the present invention and many of its attendant advantages will be readily obtained as the same becomes better understood by reference to the following detailed descriptions when considered in connection with the accompanying drawings, wherein:

FIG. 1 is a schematic diagram of a liquid crystal display device according to an embodiment of the present invention;

FIG. 2 indicates operational waveforms of an erecting image mode of the liquid crystal display device shown in FIG. 1;

FIG. 3 indicates operational waveforms of a reversed image mode of the liquid crystal display device shown in FIG. 1; and

FIG. 4 is a schematic circuit diagram of a flicker-noise compensation circuit according to the embodiment of the present invention.

### DESCRIPTION OF THE EMBODIMENTS

Embodiments of the present invention will be explained below with reference to the attached drawings. It should be noted that the present invention is not limited to the embodiments but covers their equivalents. Throughout the attached drawings, similar or same reference numerals show similar, equivalent or same components.

### Embodiment

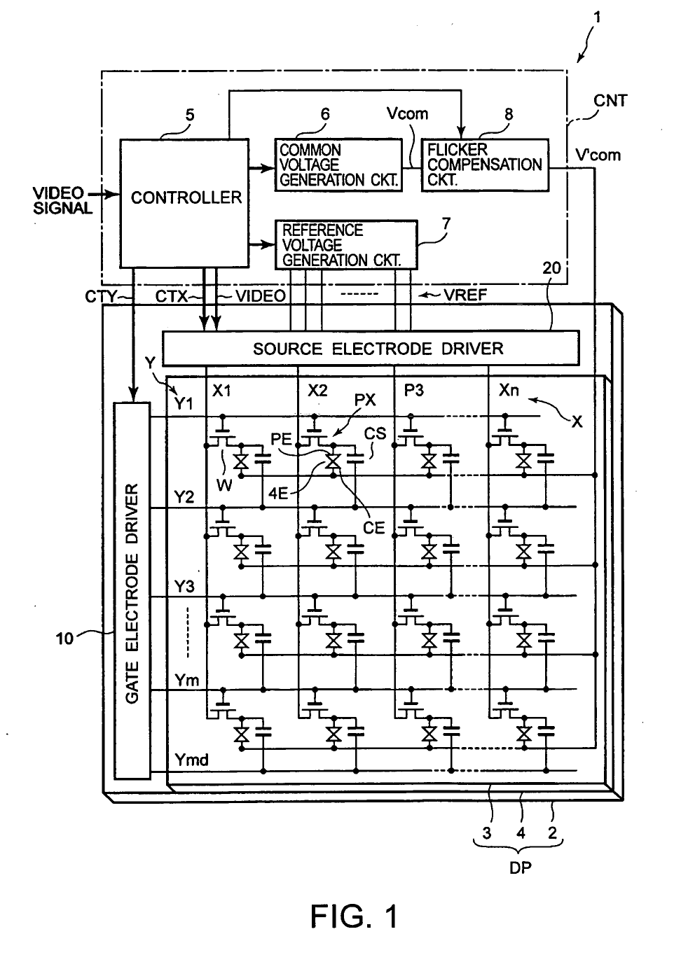

FIG. 1 is a block diagram of a liquid crystal display device according to an embodiment of the present invention. Liquid crystal display device 1 is provided with display panel DP, pixels PX formed on display panel DP and control unit CNT to control display panel DP. Display panel DP is configured to have pixel array and counter substrates 2 and 3, and liquid crystal layer 4 held between pixel array and counter substrates 2 and 3.

Pixel array substrate 2 includes pixel electrodes PE, gate electrode lines Y, (Y1-Ym), source electrode lines X, (X1-Xn), pixel switching elements W, and gate and source electrode drivers 10 and 20. Pixel electrodes PE are arranged in a matrix form on a transparent insulation substrate made of glass, for instance. Gate and source electrode lines Y and X are composed of pluralities of lines Y1-Ym and X1˜Xn, respectively. Pixel switching elements W are disposed in the vicinity of crossing points of source and gate electrode lines X and Y. Gate electrode driver 10 drives one gate electrode per horizontal scanning period while source electrode driver 20 drives a plurality of source electrode lines X during each horizontal driving period of gate electrode lines Y. Pixel switching elements W are made of poly-crystalline-silicon thin-film transistors, for instance. Gate electrodes of the thin-film transistors are connected to one of gate electrode lines Y. Gate electrode driver 10 is also composed of poly-crystalline-silicon thin-film transistors formed on the glass substrate in the same process and at the same time as pixel switching elements W. Source electrode driver 20 is composed of integrated circuits formed on pixel array substrate 2 by applying a chip-on-glass technology. Further, as modified structures, gate electrode driver 10 and/or source electrode driver 20 may be covered with counter substrate 3 or formed on a separate substrate.

Counter substrate 3 includes color filters (not shown) disposed on a transparent insulation substrate, such as a glass substrate, and common electrode CE formed on the filters and facing pixel electrodes PE. Each pixel electrode PE and common electrode CE are made of transparent electrode materials, such as indium-tin-oxide (ITO) films, and form pixels PX together with liquid crystal layer 4 held between pixel array and counter substrates 2 and 3. Equivalent circuit 4E of liquid crystal layer 4 is shown in shown in FIG. 1 in association with pixel and common electrodes PE and CE. Molecular disposition of liquid crystal layer 4 is controlled by an electric field applied between pixel and common electrodes PE and CE. All pixels PX are provided with auxiliary capacitors CS. Auxiliary capacitor CS of each pixel PX is defined by capacitive coupling between one pixel electrode PE and gate electrode line Y for the control of switching elements W for another pixel electrode PE at a next neighboring line. Auxiliary capacitor CS of pixel electrode PE is sufficiently larger in value than stray capacitors of switching element W. Dummy pixels arranged at the outside of the display matrix of pixels PX are not shown in FIG. 1 for convenience sake. Those dummy pixels, however, are configured in the same manner as pixels PX in the display matrix to make conditions of the stray capacitors or the like of pixels PX equal to each other. Gate line Ymd is provided for those dummy pixels.

Control unit CNT includes controller 5, common voltage generation circuit 6, gray-scale reference voltage generation circuit 7 and flicker compensation circuit 8. Controller 5 controls common voltage generation circuit 6, gray-scale reference-voltage generation circuit 7, gate electrode driver 10 and source electrode driver 20 to display images on display panel DP in response to digital display signal VIDEO supplied from outside equipment. Common voltage generation circuit 6 generates common voltages Vcom for common electrode CE provided on counter substrate 3. Gray-scale reference-voltage generation circuit 7 generates a predetermined number of reference voltages VREF used for the conversion of display signals into pixel voltages which are supplied to respective pixel PX. The pixel voltages are then applied to pixel electrodes PE and potentials at common electrodes CE are reference ones for the pixel voltages. Flicker compensation circuit 8 adjusts common voltages Vcom obtained from common voltage generation circuit 6 for the reduction of flicker noise as set forth below in detail.

Controller 5 outputs control signals CTY and CTX. Control signal CTY selects gate electrode line Y every vertical scanning period. Control signals CTX assigns display signals for pixels PX included in video signals every horizontal scanning period (1H as shown in FIG. 2) to source electrode lines X on one gate electrode line Y. Control signal CTY is supplied from controller 5 to gate electrode driver 10 while both control signals CTX and digital video signals VIDEO are supplied together from controller 5 to source electrode driver 20.

Gate electrode driver 10 sequentially selects gate electrode lines Y in accordance with control signal CTY and supplies selected gate electrode Y with a scanning signal to turn on switching element W. In this embodiment, a plurality of pixels PX on one gate electrode line Y are selected in turn during each horizontal scanning period.

In this liquid crystal display device 1, every horizontal scanning period during which gate electrode driver 10 supplies a scanning signal to one gate electrode line Y, source electrode driver 20 converts display signals for pixels PX on one gate electrode line Y included in digital video signals into pixel voltages and provide the pixel voltages to source electrode lines X1˜Xn sequentially. The pixel voltages on source electrode lines X1˜Xn are supplied to corresponding pixel electrodes PX through switching elements W driven by a horizontal scanning signal. Common voltage generation circuit 6 outputs common voltages Vcom and flicker compensation circuit 8 adjusts the same to supply compensated common voltages V'com to common electrode CE in synchronization with the output timing of the pixel voltages. Common voltage generation circuit 6 is composed of a D/A converter or the like to output voltages corresponding to arithmetic data set up by controller 5 as common voltages Vcom. Common voltages Vcom are alternatively reversed in level every horizontal scanning period. Thus, source electrode driver 20 reverses levels of the pixel voltages with reference to the central level of common voltages Vcom. Flicker compensation circuit 8 is controlled by controller 5 to change amplitudes and central levels of common voltages Vcom supplied from common voltage generation circuit 6 in conformity with field-through voltages caused by stray capacitors of switching elements W.

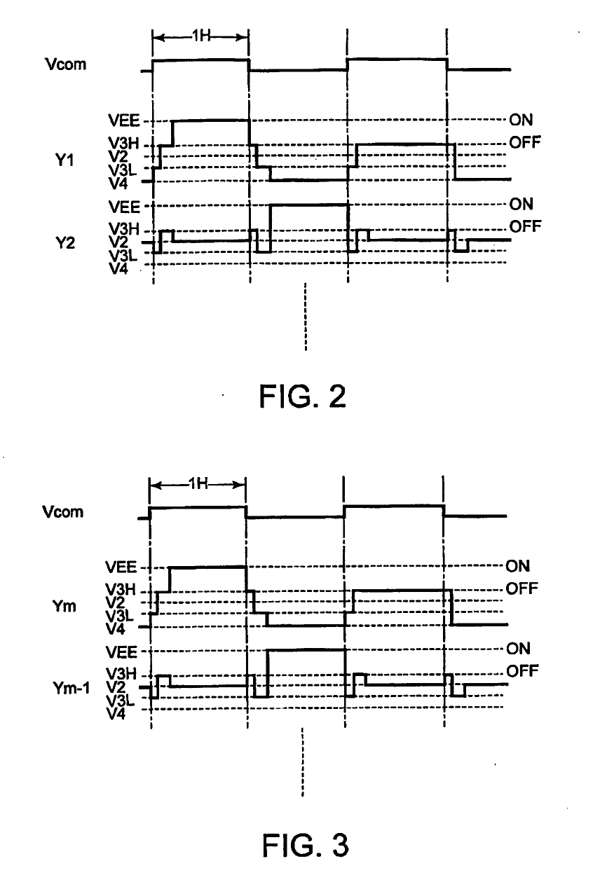

Liquid crystal display device 1 has display modes of erecting and reversed images. Controller 5 controls gate electrode driver 10 to provide horizontal scanning signals to gate electrode lines Y1, Y2, . . . in the ordinary order as shown in FIG. 2 in the display mode of erecting images. Controller 5 also controls gate electrode driver 10 to sequentially provide horizontal scanning signals to gate electrode lines Ym, Ym-1, . . . in the reverse order as shown in FIG. 3 in the display mode of reversed images. Gate electrode driver 10 outputs five different voltages of VEE (=18V), V3H (=−9.7V), V2 (=−13.3V), V3L (=−15.5V) and V4 (=−20V) in appropriate timings in order for each auxiliary capacitor CS to hold a suitable pixel voltage. The horizontal scanning signal corresponds to VEE (=18V) among the five different voltages. Pixel switching element W turns on when its corresponding gate electrode line is VEE in level and turns off otherwise.

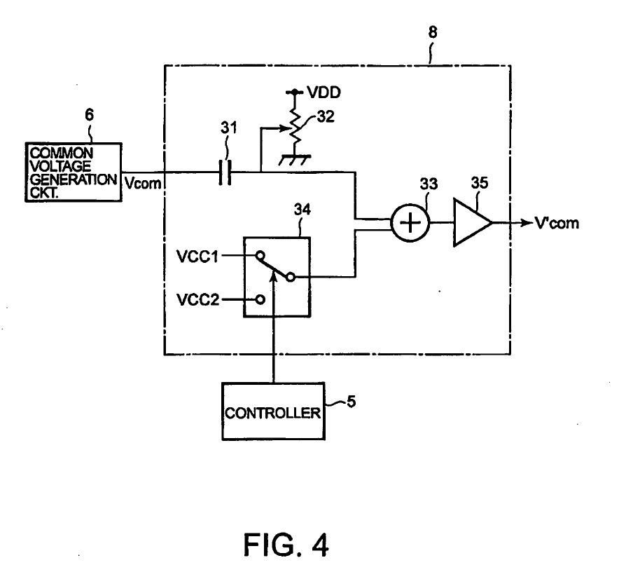

FIG. 4 shows an arrangement of flicker compensation circuit 8 depicted in FIG. 1. Flicker compensation circuit 8 is provided with capacitor 31, variable resistor 32, arithmetic operation circuit 33, switch 34 and output buffer amplifier 35. Capacitor 31 receives an output voltage generated by common voltage generation circuit 6. Variable resistor 32 is connected between voltage source terminal VDD and a ground terminal to divide a voltage applied between them, so that a central level of the voltage supplied through capacitor 31 is changed. Switch 34 selects one of first and second different voltages VCC1 and VCC2. Arithmetic operation circuit 33 adds an output voltage of variable resistor 32 to that of switch 34. Output buffer amplifier 35 provides such added voltage to common electrode CE (see FIG. 1) as common voltage V'com. Controller 5 controls switch 34 to select first voltage VCC1 in the display mode of erecting images and second voltage VCC2 in that of reversed images, respectively.

Variable resistor 32 of flicker compensation circuit 8 is used to adjust central levels of common voltages Vcom. Arithmetic operation circuit 33 adds the adjusted voltages to one of first and second voltages VCC1 and VCC2 selected by switch 34 and buffer amplifier 35 outputs such added voltages as compensated common voltages V'com. Arithmetic operation circuit 33 and buffer amplifier 35 make up an output unit. In this case, after the receipt of the output adjusted by a single adjustment of variable resistor 32, the output unit provides gate electrode lines Y1-Ym with two different common voltages V'com in accordance with horizontal scanning orders and in conformity of flicker noise. Thus, such a single variable resistor is less influenced over ambient temperatures, and adjustment time is shorter, than a plurality of resistors, so that the productivity is significantly improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A liquid crystal display device comprising:
pixels;
individual and common electrodes provided for the pixels; and
a flicker compensation circuit provided with a capacitor through which a common voltage is supplied to the flicker compensation circuit, a variable resistor which changes the common voltage supplied through the capacitor, a switch which selects one of two different voltages, and an output circuit which combines an output of the variable resistor with that of the switch and supplies thus combined outputs to the common electrode as compensated common voltages.

2. A liquid crystal display device according to claim 1, further comprising:
a controller to selectively control a first display mode with a first vertical scanning direction and a second display mode with a second vertical scanning direction reverse to said first vertical scanning direction.

3. A liquid crystal display device according to claim 2, wherein said switch selects a first voltage at the first display mode and a second voltage at the second display mode.

4. A liquid crystal display device according to claim 3, wherein said liquid crystal display device is used for a car navigation.

5. A flicker compensation circuit, comprising:
a capacitor through which a common voltage is supplied;
a variable resistor which changes the common voltage supplied through the capacitor;
a switch which selects one of two different voltages; and
an output circuit which combines an output of the variable resistor with that of the switch.
